(19) United States
(12) Patent Application Publication
(10) Pub. No.: US 2013/0332653 A1
(43) Pub. Date: Dec. 12, 2013

(54) MEMORY MANAGEMENT METHOD, AND MEMORY CONTROLLER AND MEMORY STORAGE DEVICE USING THE SAME

(71) Applicant: Chih-Kang Yeh, Kinmen County (TW)

(72) Inventor: Chih-Kang Yeh, Kinmen County (TW)

(73) Assignee: PHISON ELECTRONICS CORP., Miaoli (TW)

(21) Appl. No.: 13/585,808

(22) Filed: Aug. 14, 2012

(30) Foreign Application Priority Data
Jun. 11, 2012 (TW) 101120907

(51) Int. Cl. G06F 12/02

(52) U.S. Cl. 711/103; 711/E12.008

(57) ABSTRACT

A memory management method adapted to a rewritable non-volatile memory module having a plurality of physical erase units is provided. The operation mode of each physical erase unit is set to include three modes. A first mode indicates all physical program units to be programmable, a second mode and a third mode indicate upper physical program units to be non-programmable, but the third mode is unswitchable to the first or the second mode. The physical erase units are grouped into a first area and a second area. Each physical erase unit in the first area switchably operates in the first or the second mode, and each physical erase unit in the second area operates in the third mode. If a condition is satisfied, a physical erase unit in the first area is grouped to the second area. Thereby, the lifespan of the rewritable non-volatile memory module is prolonged.

### CROSS-REFERENCE TO RELATED APPLICATION

This application claims the priority benefit of Taiwan application serial no. 101120907, filed on Jun. 11, 2012. The entirety of the above-mentioned patent application is hereby incorporated by reference herein and made a part of this specification.

### BACKGROUND

1. Technology Field

The invention generally relates to a memory management method, and more particularly, to a memory management method for controlling a rewritable non-volatile memory module and a memory controller and a memory storage device using the same.

2. Description of Related Art

Along with the widespread of digital cameras, cell phones, and MP3 players in recently years, the consumers' demand to storage media has increased drastically. Rewritable non-volatile memory module (for example, flash memory) is one of the most adaptable storage media to aforementioned portable multimedia devices due to its many characteristics such as data non-volatility, low power consumption, small volume, and non-mechanical structure.

NAND flash memories may be categorized into single level cell (SLC) NAND flash memories multi level cell (MLC) NAND flash memories, and trinary level cell (TLC) NAND flash memories according to the number of bits stored in each memory cell. Each memory cell in a SLC NAND flash memory can store data of 1 bit (i.e., “1” and “0”), each memory cell in a MLC NAND flash memory can store data of 2 bits, and each memory cell in a TLC NAND flash memory can store data of 3 bits.

In a MLC NAND flash memory, each physical block includes a plurality of physical pages, and each physical block includes lower physical pages and upper physical pages. Besides, each physical block comes with an upper limit on its number of erases. If the erase count of a physical block exceeds the upper limit, the physical block cannot be used anymore. If only the lower physical pages of a physical block are used for storing data, the upper limit on the erase count of the physical block is greater than that if both the lower physical pages and the upper physical pages of the physical block are used for storing data. Thereby, how to manage physical blocks based on aforementioned characteristic, so as to prolong the lifespan of a rewritable non-volatile memory, has become a major subject in the industry.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

Accordingly, the exemplary embodiments of the invention are directed to a memory management method, a memory controller, and a memory storage device, in which the lifespan of a rewritable non-volatile memory is prolonged.

An exemplary embodiment of the invention provides a memory management method adapted to control a rewritable non-volatile memory module. The rewritable non-volatile memory module includes a plurality of physical erase units. Each of the physical erase units includes a plurality of physical program unit sets. Each of the physical program unit sets includes a plurality of physical program units. The physical program units in each physical program unit set include a lower physical program unit and an upper physical program unit, wherein the programming speed of the upper physical program unit is slower than that of the lower physical program unit. The memory management method includes setting the operation mode of each physical erase unit to include a first mode, a second mode, and a third mode. Herein the first mode indicates that all the physical program units are programmable, the second mode indicates that the upper physical program units are non-programmable, and the third mode indicates that the upper physical program units are non-programmable and the operation mode is unswitchable from the third mode to the first mode or the second mode. The memory management method also includes grouping the physical erase units into a first area and a second area. Herein each physical erase unit in the first area switchably operates in the first mode or the second mode, and the operation mode of each physical erase unit in the second area is the third mode. The memory management method further includes if a first physical erase unit in the first area satisfies a first condition, setting the operation mode of the first physical erase unit to the third mode and grouping the first physical erase unit to the second area.

An exemplary embodiment of the invention provides a memory storage device including a connector, a rewritable non-volatile memory module, and a memory controller. The connector is configured to couple to a host system. The rewritable non-volatile memory module includes a plurality of physical erase units. Each of the physical erase units includes a plurality of physical program unit sets. Each of the physical program unit sets includes a plurality of physical program units. The physical program units in each physical program unit set include a lower physical program unit and an upper physical program unit, wherein the programming speed of the upper physical program unit is slower than that of the lower physical program unit. The memory controller is coupled to the connector and the rewritable non-volatile memory module. The memory controller sets the operation mode of each physical erase unit to include a first mode, a second mode, and a third mode. Herein the first mode indicates that all the physical program units are programmable, the second mode indicates that the upper physical program units are non-programmable, and the third mode indicates that the upper physical program units are non-programmable and the operation mode is unswitchable from the third mode to the first mode or the second mode. The memory controller also groups the physical erase units into a first area and a second area. Herein each physical erase unit in the first area switchably operates in the first mode or the second mode, and the operation mode of each physical erase unit in the second area is the third mode. If a first physical erase unit in the first area satisfies a first condition, the memory controller sets the operation mode of the first physical erase unit to the third mode and groups the first physical erase unit to the second area.

An exemplary embodiment of the invention provides a memory controller including a host interface, a memory interface, and a memory management circuit. The host interface is configured to couple to a host system. The memory interface is configured to couple to a rewritable non-volatile memory module. The rewritable non-volatile memory module includes a plurality of physical erase units. Each of the physical erase units includes a plurality of physical program unit sets. Each of the physical program unit sets includes a plurality of physical program units. The physical program units in each physical program unit set include a lower physical program unit and an upper physical program unit, wherein the programming speed of the upper physical program unit is slower than that of the lower physical program unit. The memory management circuit is coupled to the host interface and the memory interface.

The memory management circuit sets the operation mode of each physical erase unit to include a first mode, a second mode, and a third mode. Herein the first mode indicates that all the physical program units are programmable, the second mode indicates that the upper physical program units are non-programmable, and the third mode indicates that the upper physical program units are non-programmable and the operation mode is unswitchable from the third mode to the first mode or the second mode. The memory management circuit also groups the physical erase units into a first area and a second area. Herein each physical erase unit in the first area switchably operates in the first mode or the second mode, and the operation mode of each physical erase unit in the second area is the third mode. If a first physical erase unit in the first area satisfies a first condition, the memory management circuit sets the operation mode of the first physical erase unit to the third mode and groups the first physical erase unit to the second area.

As described above, in a memory management method, a memory controller, and a memory storage device provided by exemplary embodiments of the invention, physical erase units are grouped into a first area and a second area, and the physical erase units in the second area are set to a third mode permanently. Thereby, the lifespan of a rewritable non-volatile memory is prolonged.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

These and other exemplary embodiments, features, aspects, and advantages of the invention will be described and become more apparent from the detailed description of exemplary embodiments if read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A illustrates a host system and a memory storage device according to an exemplary embodiment.

FIG. 1B is a diagram of a computer, an input/output (I/O) device, and a memory storage device according to an exemplary embodiment.

FIG. 1C is a diagram of a host system and a memory storage device according to an exemplary embodiment.

FIG. 2 is a schematic block diagram of the memory storage device in FIG. 1A.

FIG. 3 is a schematic block diagram of a memory controller according to an exemplary embodiment.

FIG. 4 is a diagram illustrating an example of operation modes of physical erase units according to an exemplary embodiment.

FIG. 5 is a diagram illustrating an example of grouping physical erase units into a first area and a second area according to an exemplary embodiment.

FIG. 6 is a diagram illustrating an example of writing data according to an exemplary embodiment.

FIG. 7 is a diagram illustrating an example of reading a physical program unit according to an exemplary embodiment.

FIG. 8 is a flowchart of a memory management method according to an exemplary embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally speaking, a memory storage device (also referred to as a memory storage system) includes a rewritable non-volatile memory module and a controller (also referred to as a control circuit). A memory storage device is usually used with a host system so that the host system can write data into or read data from the memory storage device.

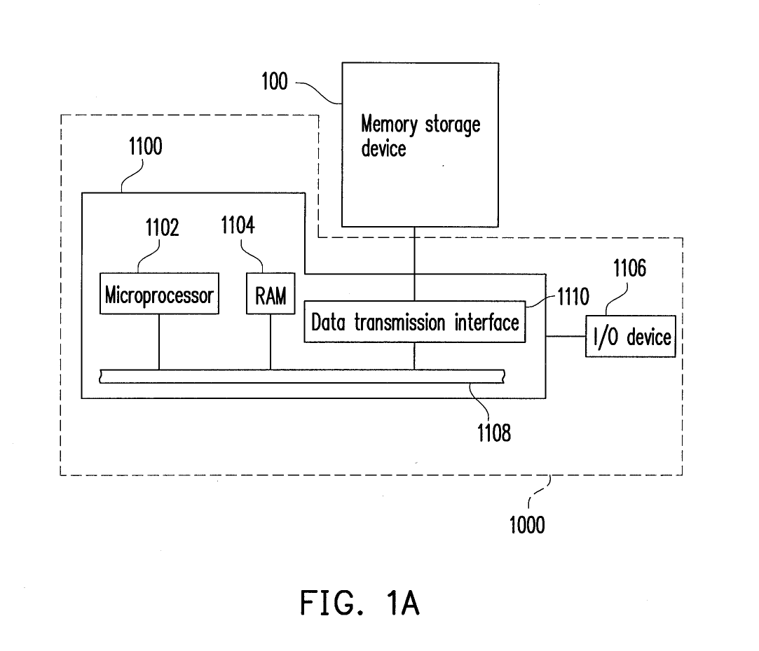

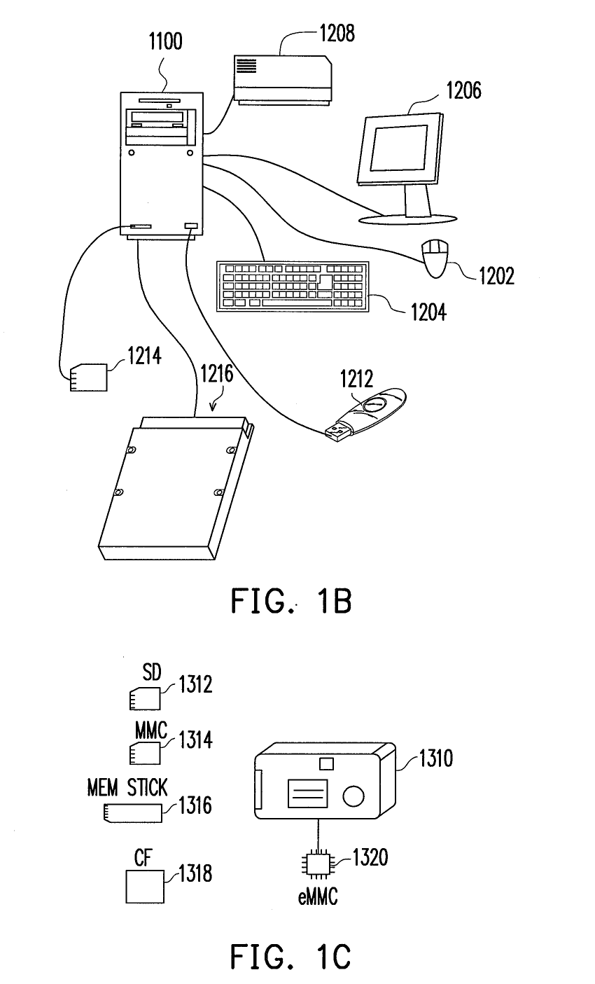

FIG. 1A illustrates a host system and a memory storage device according to an exemplary embodiment.

Referring to FIG. 1A, the host system 1000 includes a computer 1100 and an input/output (I/O) device 1106. The computer 1100 includes a microprocessor 1102, a random access memory (RAM) 1104, a system bus 1108, and a data transmission interface 1110. The I/O device 1106 includes a mouse 1202, a keyboard 1204, a display 1206, and a printer 1208, as shown in FIG. 1B. It should be understood that the I/O device 1106 is not limited to the devices illustrated in FIG. 1B and may further include other devices.

In the present embodiment, the memory storage device 100 is coupled to other components of the host system 1000 through the data transmission interface 1110. Data can be written into or read from the memory storage device 100 through operations of the microprocessor 1102, the RAM 1104, and the I/O device 1106. The memory storage device 100 may be a rewritable non-volatile memory storage device, such as the flash drive 1212, the memory card 1214, or the solid state drive (SSD) 1216 illustrated in FIG. 1B.

Generally speaking, the host system 1000 can be substantially any system that works with the memory storage device 100 to store data. Even tough the host system 1000 is described as a computer system in the present exemplary embodiment, in another exemplary embodiment of the invention, the host system 1000 may also be a digital camera, a video camera, a communication device, an audio player, or a video player. For example, if the host system is a digital camera (video camera) 1310, the rewritable non-volatile memory storage device is then a secure digital (SD) card 1312, a multi media card (MMC) card 1314, a memory stick (MS) 1316, a compact flash (CF) card 1318, or an embedded storage device 1320 (as shown in FIG. 1C) used by the digital camera (video camera) 1310. The embedded storage device 1320 includes an embedded MMC (eMMC). It should be mentioned that an eMMC is directly coupled to the motherboard of a host system.

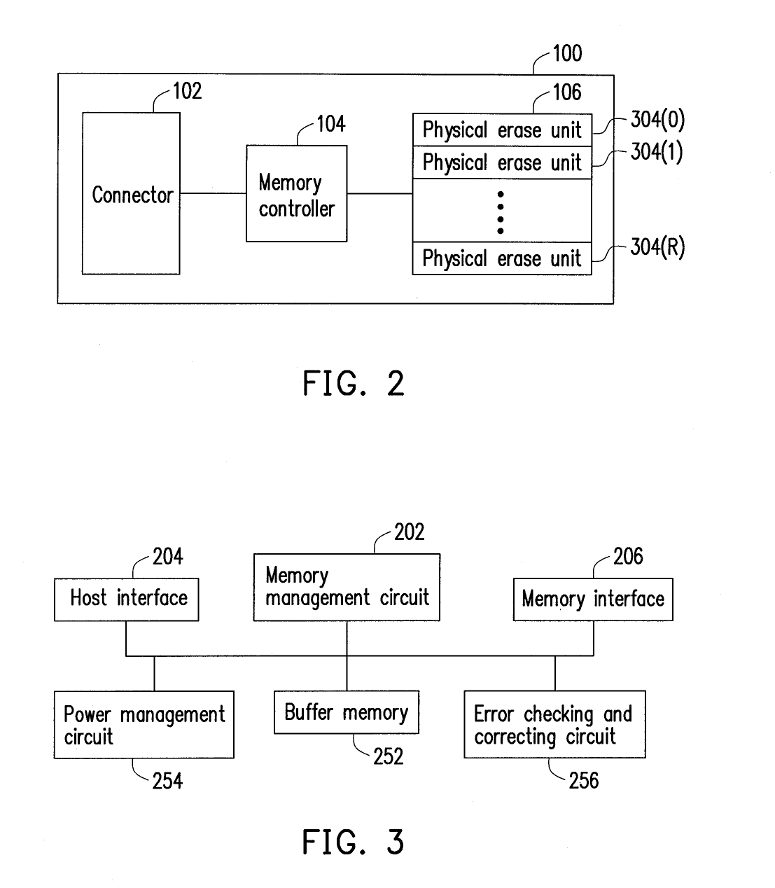

FIG. 2 is a schematic block diagram of the memory storage device in FIG. 1A.

Referring to FIG. 2, the memory storage device 100 includes a connector 102, a memory controller 104, and a rewritable non-volatile memory module 106.

In the present exemplary embodiment, the connector 102 complies with the serial advanced technology attachment (SATA) standard. However, the invention is not limited thereto, and the connector 102 may also comply with the parallel advanced technology attachment (PATA) standard, the Institute of Electrical and Electronic Engineers (IEEE) 1394 standard, the peripheral component interconnect (PCI) express standard, the universal serial bus (USB) standard, the secure digital (SD) interface standard, the ultra high speed-I (UHS-I) interface standard, the ultra high speed-II (UHS-II) interface standard, the memory stick (MS) interface standard, the MMC interface standard, the eMMC interface standard, the universal flash storage (UFS) interface standard, the compact flash (CF) interface standard, the integrated device electronics (IDE) standard, or any other suitable standard.

The memory controller 104 executes a plurality of logic gates or control instructions implemented in a hardware form or a firmware form and performs various data operations on the rewritable non-volatile memory module 106 according to commands issued by the host system 1000.

The rewritable non-volatile memory module 106 is coupled to the memory controller 104 and configured to store data written by the host system 1000. The rewritable non-volatile memory module 106 has physical erase units 304(0)-304(R). The physical erase units 304(0)-304(R) may belong to a same memory die or different memory dies. Each physical erase unit has a plurality of physical program unit sets, and each of the physical program unit sets includes a plurality of physical program units. The physical program units belonging to the same physical erase unit can be individually written but have to be erased all together. Each physical erase unit may be composed of 128 physical program units. However, the invention is not limited thereto, and each physical erase unit may also be composed of 64, 256, or any other number of physical program units.

To be specific, physical erase unit is the smallest unit for erasing data. Namely, each physical erase unit contains the least number of memory cells that are erased all together. Physical program unit is the smallest unit for programming data. Namely, physical program unit is the smallest unit for writing data. Each physical program unit usually includes a data bit area and a redundant bit area. The data bit area includes a plurality of physical access addresses for storing user data, and the redundant bit area is used for storing system data (for example, error checking and correcting codes (ECCs)). In the present exemplary embodiment, the data bit area of each physical program unit includes 4 physical access addresses, and the size of each physical access address is 512 bytes (B). However, the size and number of the physical access addresses are not limited in the invention, and in other exemplary embodiments, the data bit area may also include 8, 16, or a greater or smaller number of physical access addresses. The physical erase units may be physical blocks, and the physical program units may be physical pages.

In the present exemplary embodiment, the rewritable non-volatile memory module 106 is a multi level cell (MLC) NAND flash memory module (i.e., a memory cell stores data of at least 2 bits). Namely, memory cells arranged on the same word line constitute a lower physical program unit and an upper physical program unit. The physical program units in a physical program unit set include a lower physical program unit and an upper physical program unit. Herein the writing speed of the lower physical program unit is faster than that of the upper physical program unit. On the other hand, each physical erase unit comes with an upper limit on its erase count. If only the lower physical program units are used, the upper limit on the erase count is a first threshold (for example, 5000 times). If both the lower physical program units and the upper physical program units are used, the upper limit on the erase count is a second threshold (for example, 50000 times). The second threshold is greater than the first threshold. However, in other exemplary embodiments, the rewritable non-volatile memory module 106 may also be a trinary level cell (TLC) NAND flash memory module, another flash memory module, or another memory module with the same characteristics.

FIG. 3 is a schematic block diagram of a memory controller according to an exemplary embodiment.

Referring to FIG. 3, the memory controller 104 includes a memory management circuit 202, a host interface 204, and a memory interface 206.

The memory management circuit 202 controls the overall operation of the memory controller 104. To be specific, the memory management circuit 202 has a plurality of control instructions, and if the memory storage device 100 is in operation, the control instructions are executed to perform data writing, data reading, and data erasing operations.

In the present exemplary embodiment, the control instructions of the memory management circuit 202 are implemented in a firmware form. For example, the memory management circuit 202 has a microprocessor unit (not shown) and a read-only memory (ROM, not shown), and the control instructions are burnt into the ROM. If the memory storage device 100 is in operation, the control instructions are executed by the microprocessor unit to carry out data writing, data reading, and data erasing operations.

In another exemplary embodiment of the invention, the control instructions of the memory management circuit 202 may also be stored in a specific area of the rewritable non-volatile memory module 106 (for example, a system area exclusively used for storing system data in a memory module) as program codes. In addition, the memory management circuit 202 has a microprocessor unit (not shown), a ROM (not shown), and a RAM (not shown). In particular, the ROM has a driving code segment. If the memory controller 104 is enabled, the microprocessor unit first executes the driving code segment to load the control instructions from the rewritable non-volatile memory module 106 into the RAM of the memory management circuit 202. Thereafter, the microprocessor unit runs the control instructions to perform various data operations.

In yet another exemplary embodiment of the invention, the control instructions of the memory management circuit 202 may also be implemented in a hardware form. For example, the memory management circuit 202 includes a microcontroller, a memory management unit, a memory writing unit, a memory reading unit, a memory erasing unit, and a data processing unit. The memory management unit, the memory writing unit, the memory reading unit, the memory erasing unit, and the data processing unit are coupled to the microcontroller. The memory management unit is configured to manage the physical erase units of the rewritable non-volatile memory module 106. The memory writing unit is configured to issue a write command to the rewritable non-volatile memory module 106 to write data into the rewritable non-volatile memory module 106. The memory reading unit is configured to issue a read command to the rewritable non-volatile memory module 106 to read data from the rewritable non-volatile memory module 106. The memory erasing unit is configured to issue an erase command to the rewritable non-volatile memory module 106 to erase data from the rewritable non-volatile memory module 106. The data processing unit is configured to process data to be written into and read from the rewritable non-volatile memory module 106.

The host interface 204 is coupled to the memory management circuit 202 and configured to receive and identify commands and data from the host system 1000. Namely, commands and data transmitted by the host system 1000 are transmitted to the memory management circuit 202 through the host interface 204. In the present exemplary embodiment, the host interface 204 complies with the SATA standard. However, the invention is not limited thereto, and the host interface 204 may also comply with the PATA standard, the IEEE 1394 standard, the PCI express standard, the USB standard, the SD standard, the MS standard, the MMC standard, the CF standard, the IDE standard, or any other suitable data transmission standard.

The memory interface 206 is coupled to the memory management circuit 202 and configured to access the rewritable non-volatile memory module 106. Namely, data to be written into the rewritable non-volatile memory module 106 is converted by the memory interface 206 into a format acceptable to the rewritable non-volatile memory module 106.

In an exemplary embodiment of the invention, the memory controller 104 further includes a buffer memory 252, a power management circuit 254, and an ECC circuit 256.

The buffer memory 252 is coupled to the memory management circuit 202 and configured to temporarily store data and commands from the host system 1000 or data from the rewritable non-volatile memory module 106.

The power management circuit 254 is coupled to the memory management circuit 202 and configured to control the power supply of the memory storage device 100.

The ECC circuit 256 is coupled to the memory management circuit 202 and configured to execute an ECC procedure to ensure data accuracy. To be specific, if the memory management circuit 202 receives a write command from the host system 1000, the ECC circuit 256 generates a corresponding ECC code for the data corresponding to the write command, and the memory management circuit 202 writes the data corresponding to the write command and the corresponding ECC code into the rewritable non-volatile memory module 106. Subsequently, if the memory management circuit 202 reads the data from the rewritable non-volatile memory module 106, it also reads the ECC code corresponding to the data, and the ECC circuit 256 executes the ECC procedure on the data according to the ECC code.

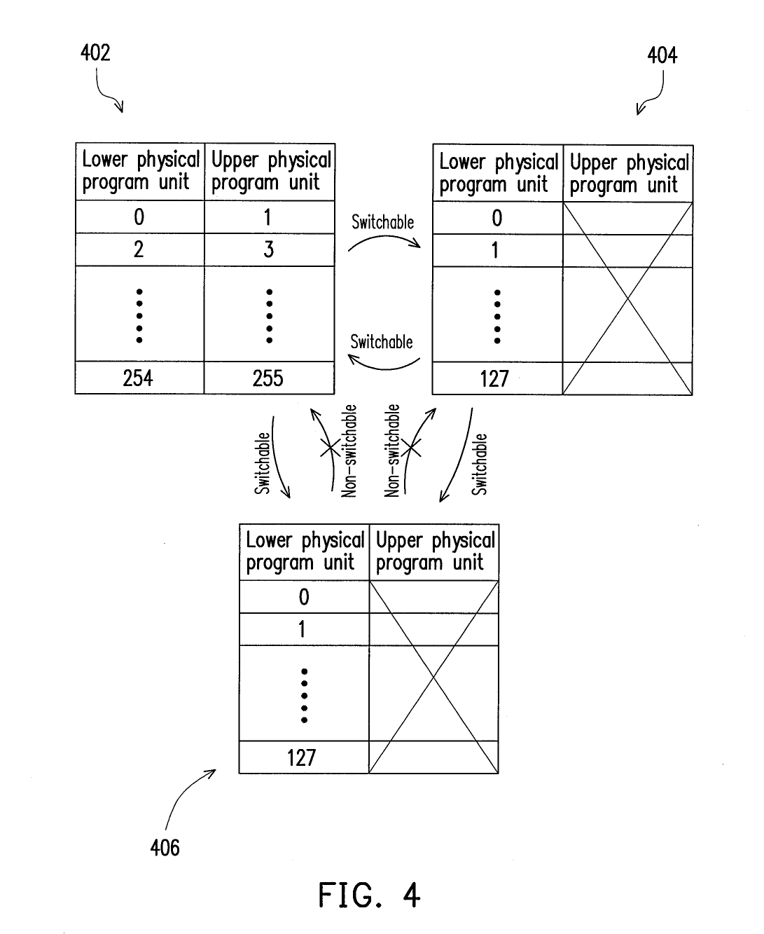

FIG. 4 is a diagram illustrating an example of operation modes of physical erase units according to an exemplary embodiment.

Referring to FIG. 4, each physical erase unit has an operation mode, and the memory management circuit 202 can respectively switch the operation modes of the physical erase units. To be specific, the memory management circuit 202 sets the operation mode of a physical erase unit to include a first mode 402, a second mode 404, and a third mode 406. Programmable physical program units are defined in a physical erase unit by these modes. The first mode 402 indicates that all the physical program units in a physical erase unit are programmable (for example, the physical addresses 0-255). The second mode 404 indicates that the upper physical program units in a physical erase unit are non-programmable. In other words, only the lower physical program units are programmable (for example, the physical addresses 0-127). The third mode 406 also indicates that the upper physical program units in a physical erase unit are non-programmable. However, the memory management circuit 202 can switch the physical erase unit between the first mode 402 and the second mode 404 but not from the third mode 406 to the first mode 402 or the second mode 404. If the operation mode of a physical erase unit is the first mode 402, the upper limit on the erase count of the physical erase unit is the first threshold. If the operation mode of a physical erase unit is the second mode 404 or the third mode 406, the upper limit on the erase count of the physical erase unit is the second threshold. However, if the operation mode of a physical erase unit is the second mode 404, if the erase count of the physical erase unit exceeds the first threshold and the operation mode thereof is switched to the first mode 402, the physical erase unit becomes a bad physical erase unit. Thus, in the present exemplary embodiment, the memory management circuit 202 sets those physical erase units having their erase counts over the first threshold to the third mode 406 so that the operation mode of these physical erase units is unswitchable to the first mode 402 or the second mode 404.

In another exemplary embodiment, the rewritable non-volatile memory module 106 may also be a trinary level cell (TLC) NAND flash memory module. In other words, each memory cell can store data of multiple bits, such as 3 bits, 4 bits, or other numbers of bits. Namely, each physical program unit set further includes at least one middle physical program unit. Herein the programming speed of the middle physical program unit is faster than that of the upper physical program unit but slower than that of the lower physical program unit. Besides, if there are multiple middle physical program units, these middle physical program units may have different programming speeds. Herein the first mode 402 indicates that the lower physical program units, the middle physical program units, and the upper physical program units are all programmable, and the second mode 404 and the third mode 406 indicate that the upper physical program units and the middle physical program units are non-programmable, the lower physical program units are programmable, and the third mode 406 is unswitchable to another mode.

To be specific, the memory management circuit 202 records the operations modes of the physical erase units 304(0)-304(R) into a mapping table. For example, each operation mode (i.e., the first mode 402, the second mode 404, or the third mode 406) is recorded with two bits. However, the invention is not limited thereto, and in other exemplary embodiments, the memory management circuit 202 may also record the operation modes with other symbols or more bits.

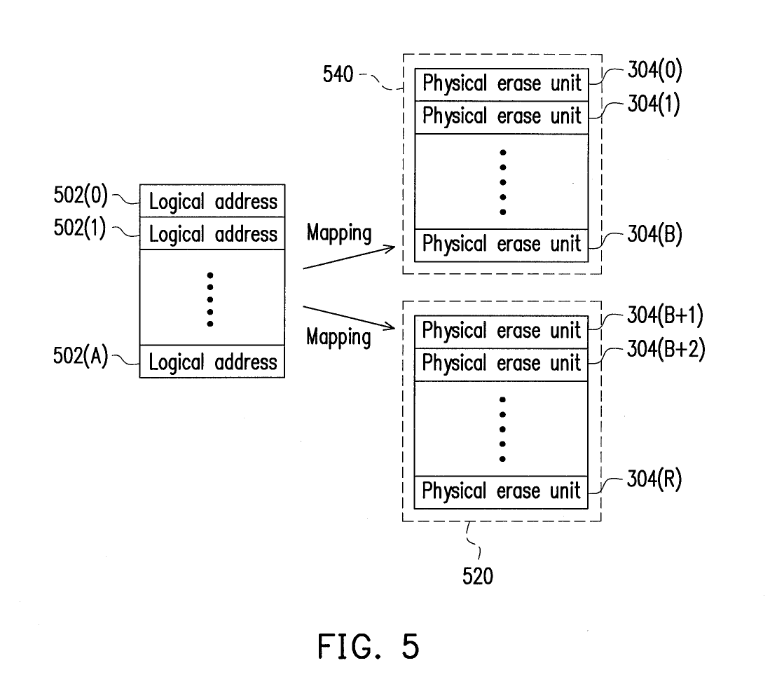

FIG. 5 is a diagram illustrating an example of grouping physical erase units into a first area and a second area according to an exemplary embodiment.

Referring to FIG. 5, the memory management circuit 202 groups the physical erase units 304(0)-304(R) into at least a first area 520 and a second area 540. The first area 520 includes the physical erase units 304(0)-304(B), and the second area 540 includes the physical erase units 304(B+1)-304(R). Each physical erase unit in the first area 520 switchably operates in the first mode 402 or the second mode 404, and each physical erase unit in the second area 540 operates in the third mode 406. However, the invention is not limited thereto, and in other exemplary embodiments, the memory management circuit 202 may also group the physical erase units 304(0)-304(R) into other areas.

Additionally, the memory management circuit 202 configures logical addresses 502(0)-502(A) for the host system 1000. These logical addresses are mapped to a part of the physical program units in the physical erase units 304(0)-304(R). In the present exemplary embodiment, the memory management circuit 202 manages the rewritable non-volatile memory module 106 in units of physical program unit. Namely, each logical address is mapped to a physical program unit. The memory management circuit 202 maintains a logical address-physical program unit mapping table for recording the mapping relationship between the logical addresses 502(0)-502(A) and the physical program units of the physical erase units 304(0)-304(R).

On the other hand, after a flash memory chip is manufactured, a plurality of physical program units therein is usually reserved for replacement or other purposes in its operation process. Namely, after a flash memory chip is just manufactured, the total capacity of memory spaces corresponding to the logical addresses 502(0)-502(A) is smaller than the total capacity of the memory space of the rewritable non-volatile memory module 106. For example, the total capacity of the memory spaces of the physical erase units 304(0)-304(R) is 100 GB, while the total capacity of the memory spaces corresponding to the logical addresses 502(0)-502(A) is 93 GB. The aggregate of the memory spaces corresponding to the logical addresses 502(0)-502(A) is also referred to as an open memory space, and the open memory space is provided to the host system 1000. Moreover, in the flash memory chip, the capacity of all the physical program units that can be mapped to the logical addresses 502(0)-502(A) or the memory space that can be used for storing user information (for example, videos or text files) is also referred to as an available memory space capacity.

Those physical program units not mapped to the logical addresses 502(0)-502(A) can be grouped into a system area and a spare area. It should be mentioned that the system area and the spare area are logical concepts. In an exemplary embodiment, the physical program units in the system area are distributed in the first area 520, and the physical program units in the spare area are distributed in the first area 520 and the second area 540. However, the invention is not limited thereto, and the physical program units in the system area may also be distributed in the second area 540.

The system area is used for storing system data. The system data includes the manufacturer and model of the memory chip, the number of physical erase units in the memory chip, and the number of physical program units in each physical erase unit, etc.

The physical program units in the spare area are used as temporary physical erase units. To be specific, if the host system 1000 is about to update data stored in the rewritable non-volatile memory module 106, it issues a write command for accessing the logical addresses 502(0)-502(A) and a write data to the memory management circuit 202. Since data cannot be written into a physical erase unit before the physical erase unit is erased, the memory management circuit 202 uses the physical program units not mapped to the logical addresses 502(0)-502(A) as temporary physical program units. The memory management circuit 202 writes the write data into theses temporary physical program units. In particular, the memory management circuit 202 uses the physical erase units in the second area 540 first for temporarily storing data.

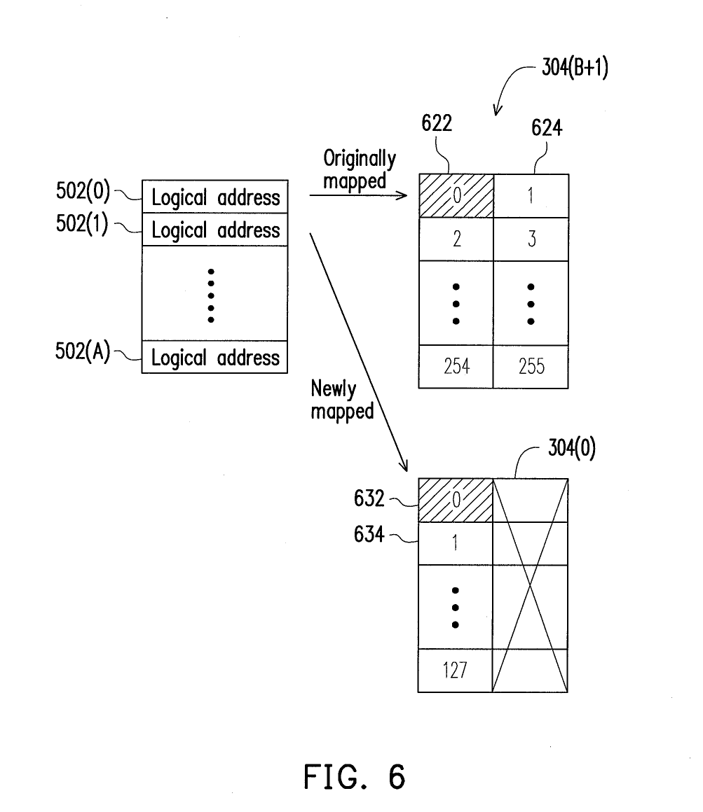

FIG. 6 is a diagram illustrating an example of writing data according to an exemplary embodiment.

Referring to FIG. 6, the operation mode of the physical erase unit 304(B+1) is the first mode, and the operation mode of the physical erase unit 304(0) is the third mode. The logical address 502(0) is originally mapped to the lower physical program unit 622 of the physical erase unit 304(B+1). Herein it is assumed that the host system 1000 transmits a write command for updating the logical address 502(0) and a write data to the memory management circuit 202. After receiving the write command, the memory management circuit 202 programs the write data into the spare physical program unit 632 even though the physical erase unit 304(B+1) has spare physical program units (for example, the physical program unit 624). After that, the memory management circuit 202 re-maps the logical address 502(0) to the physical program unit 632. Thus, data stored in the physical program unit 622 is invalid. For example, the host system 1000 continues to issue a write command for accessing the logical address 502(0) to the memory management circuit 202. The memory management circuit 202 programs the write data into the spare physical program unit 634. Next, the memory management circuit 202 re-maps the logical address 502(0) to the physical program unit 632. After foregoing operations are completed, data stored in the physical program units 622 and 632 is invalid data, while data stored in the physical program unit 634 is valid data.

Once there is no more spare physical program unit in the physical erase unit 304(0), the memory management circuit 202 copies valid data in the physical erase unit 304(0) to the physical erase unit 304(B+1). Besides, the memory management circuit 202 executes an erase operation on the physical erase unit 304(0) so that the physical erase unit 304(0) can be used for storing other data. In other words, because the physical program units in the physical erase unit 304(0) are used first as temporary physical program units, the erase count of the physical erase unit 304(0) is higher than that of the physical erase unit 304(B+1).

However, the memory management circuit 202 may also use the physical program units of a plurality of physical erase units in the second area 540 as temporary physical program units. The memory management circuit 202 can copy valid data to the first area 520 only if there is no more spare physical program unit in the physical erase units in the second area 540. The invention is not limited herein. In other words, the memory management circuit 202 can focus the erase count of the rewritable non-volatile memory module 106 on the physical erase units in the second area 540. However, the invention is not limited thereto, and in other exemplary embodiments, the physical program units in the first area 520 may also be used as temporary physical program units.

In addition, if a physical erase unit in the first area 520 satisfies a first condition (i.e., in the present exemplary embodiment, if whether a physical erase unit in the first area 520 is a risky erase unit (i.e., a physical erase unit prone to programming error or reading error) is determined), the memory management circuit 202 sets the physical erase unit to the third mode 406 and groups it to the second area 540.

For example, if the erase count of the physical erase unit 304(B+1) (also referred to as a first physical erase unit) is greater than a first threshold, the memory management circuit 202 determines whether the physical erase unit 304(B+1) satisfies the first condition. In other words, the memory management circuit 202 switches the operation mode of the physical erase unit 304(B+1) from the first mode 402 to the third mode 406 and groups the physical erase unit 304(B+1) to the second area 540. Because the upper limit on the erase count of a physical erase unit increases (changes from the first threshold to the second threshold) if the physical erase unit operates in the third mode 406, the physical erase unit 304(B+1) can still be used after it is grouped to the second area 540. However, the invention is not limited thereto, and the memory management circuit 202 may also switch a physical erase unit from the second mode 404 to the third mode 406 and groups the physical erase unit from the first area 520 to the second area 540.

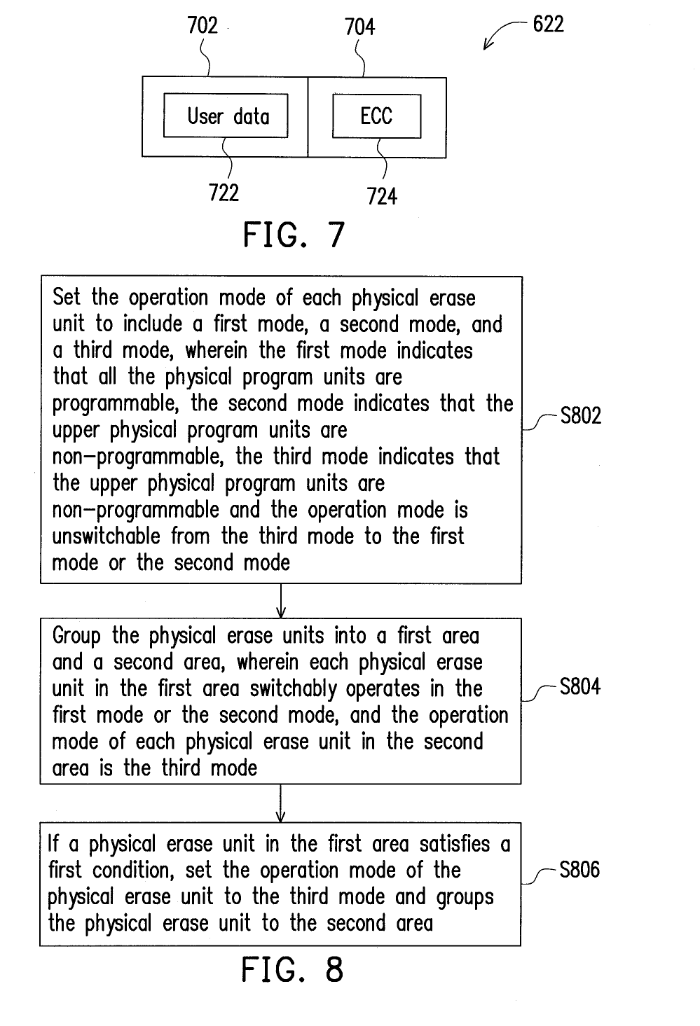

FIG. 7 is a diagram illustrating an example of reading a physical program unit according to an exemplary embodiment.

Referring to FIG. 7, while reading a physical program unit, the memory management circuit 202 reads the ECC from the redundant bit area and determines whether an error occurs in the user data in the data bit area according to the ECC. For example, the physical erase unit 304(B+1) includes physical program unit 622 (also referred to as a first physical program unit), and the physical program unit 622 includes a data bit area 702 and a redundant bit area 704. The data bit area 702 stores a user data 722, and the redundant bit area 704 stores an ECC 724. While reading the physical program unit 622, the memory management circuit 202 determines whether an error occurs in the user data 722 according to the ECC 724. If an error occurs in the user data 722, the memory management circuit 202 determines whether an error bit number of the user data 722 exceeds a predetermined value. The error bit number is the number of erroneous bits in the user data 722. If the error bit number of the user data 722 exceeds the predetermined value, the memory management circuit 202 determines that the physical erase unit 304(B+1) satisfies the first condition. In other words, the memory management circuit 202 switches the operation mode of the physical erase unit 304(B+1) to the third mode 406 and groups the physical erase unit 304(B+1) to the second area 540. The predetermined value may be the upper limit on the number or erroneous bits that can be corrected according to the ECC 724. However, the invention is not limited thereto, and in other exemplary embodiments, the predetermined value may also be set to other values.

As described above, the available memory space capacity is the total capacity of memory spaces of physical erase units that are mapped to the logical addresses 502(0)-502(A) and can be used for storing user data. However, after the physical erase unit 304(B+1) is switched from the first area 520 to the second area 540, since only lower physical program units of the physical erase unit 304(B+1) can be used, the number of available physical program units in the physical erase unit 304(B+1) is reduced. After grouping the physical erase unit 304(B+1) to the second area 540, the memory management circuit 202 determines whether the available memory space capacity is smaller than the total capacity of the memory spaces corresponding to the logical addresses 502(0)-502(A) (i.e., the capacity of the open memory space). If the available memory space capacity is smaller than the capacity of the open memory space, the memory management circuit 202 declares that the rewritable non-volatile memory module 106 enters a write protect state. Namely, data can be read from but cannot be written into the rewritable non-volatile memory module 106.

FIG. 8 is a flowchart of a memory management method according to an exemplary embodiment.

Referring to FIG. 8, in step S802, the memory management circuit 202 sets the operation mode of each physical erase unit to include a first mode, a second mode, and a third mode. The first mode indicates that all the physical program units are programmable, the second mode indicates that the upper physical program units are non-programmable, the third mode indicates that the upper physical program units are non-programmable and the operation mode is unswitchable from the third mode to the first mode or the second mode.

In step S804, the memory management circuit 202 groups the physical erase units into a first area and a second area. Herein each physical erase unit in the first area switchably operates in the first mode or the second mode, and the operation mode of each physical erase unit in the second area is the third mode.

In step S806, if a physical erase unit in the first area satisfies a first condition, the memory management circuit 202 sets the operation mode of the physical erase unit to the third mode and groups the physical erase unit to the second area.

Various steps in FIG. 8 have been described above in detail therefore will not be described herein.

As described above, in a memory management method, a memory controller, and a memory storage device provided by exemplary embodiments of the invention, the operation mode of a physical erase unit is set to include three modes so that the erasing operations are focused on those physical erase units with greater erase count upper limit, and accordingly the lifespan of a rewritable non-volatile memory is prolonged.

The previously described exemplary embodiments of the present invention have the advantages aforementioned, wherein the advantages aforementioned not required in all versions of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A memory management method, for a rewritable non-volatile memory module, wherein the rewritable non-volatile memory module comprises a plurality of physical erase units, each of the physical erase units comprises a plurality of physical program unit sets, each of the physical program unit sets comprises a plurality of physical program units, and the physical program units of each of the physical program unit sets comprise a lower physical program unit and an upper physical program unit, wherein a programming speed of the upper physical program units is slower than a programming speed of the lower physical program units, the memory management method comprising:
setting an operation mode of each of the physical erase units to comprise a first mode, a second mode, and a third mode, wherein the first mode indicates that the physical program units are programmable, the second mode indicates that the upper physical program units are non-programmable, the third mode indicates that the upper physical program units are non-programmable and the operation mode is unswitchable from the third mode to the first mode or the second mode;
grouping the physical erase units into a first area and a second area, wherein each of the physical erase units in the first area switchably operates in the first mode or the second mode, and the operation mode of each of the physical erase units in the second area is the third mode; and
if a first physical erase unit in the first area satisfies a first condition, setting the operation mode of the first physical erase unit to the third mode, and grouping the first physical erase unit to the second area.

2. The memory management method according to claim 1 further comprising:
if an erase count of the first physical erase unit is greater than a threshold, determining that the first physical erase unit satisfies the first condition.

3. The memory management method according to claim 1, wherein each of the physical program units comprises a data bit area and a redundant bit area, the data bit area is used for storing a user data, and the redundant bit area is used for storing an error checking and correcting code (ECC), the memory management method further comprising:
reading a first physical program unit among the physical program units of the first physical erase unit;
determining whether an error occurs in the user data in the first physical program unit according to the ECC in the first physical program unit;
if an error occurs in the user data in the first physical program unit, determining whether an error bit number of the user data exceeds a predetermined value; and
if the error bit number exceeds the predetermined value, determining that the first physical erase unit satisfies the first condition.

4. The memory management method according to claim 3, wherein the step of determining whether the error bit number of the user data in the first physical program unit exceeds the predetermined value comprises:
setting the predetermined value to an upper limit on a number of error bits correctable to the ECC in the first physical program unit.

5. The memory management method according to claim 1 further comprising:
configuring a plurality of logical addresses to be mapped to a part of the physical program units, wherein an aggregate of memory spaces corresponding to the logical addresses is an open memory space;
determining whether an available memory space capacity of the physical erase units is smaller than a capacity of the open memory space after the first physical erase unit is grouped to the second area, wherein the available memory space capacity is a total of capacities of the physical erase units that are available for storing user information; and
if the available memory space capacity is smaller than the capacity of the open memory space, declaring that the rewritable non-volatile memory module enters a write protect state.

6. The memory management method according to claim 1 further comprising:
establishing a mapping table, wherein the mapping table is used for recording the operation mode of each of the physical erase units.

7. A memory storage device, comprising:
a connector, configured to couple to a host system;
a rewritable non-volatile memory module, comprising a plurality of physical erase units, wherein each of the physical erase units comprises a plurality of physical program unit sets, each of the physical program unit sets comprises a plurality of physical program units, and the physical program units of each of the physical program unit sets comprise a lower physical program unit and an upper physical program units, wherein a programming speed of the upper physical program units is slower than a programming speed of the lower physical program units; and
a memory controller, coupled to the connector and the rewritable non-volatile memory module, configured to set an operation mode of each of the physical erase units to comprise a first mode, a second mode, and a third mode, wherein the first mode indicates that the physical program units are programmable, the second mode indicates that the upper physical program units are non-programmable, the third mode indicates that the upper physical program units are non-programmable and the operation mode is unswitchable from the third mode to the first mode or the second mode,
wherein the memory controller is configured to group the physical erase units into a first area and a second area, wherein each of the physical erase units in the first area switchably operates in the first mode or the second mode, and the operation mode of each of the physical erase units in the second area is the third mode,
wherein if a first physical erase unit in the first area satisfies a first condition, the memory controller is configured to set the operation mode of the first physical erase unit to the third mode and group the first physical erase unit to the second area.

8. The memory storage device according to claim 7, wherein the memory controller is further configured to determine that the first physical erase unit satisfies the first condition if an erase count of the first physical erase unit is greater than a threshold.

9. The memory storage device according to claim 7, wherein each of the physical program units comprises a data bit area and a redundant bit area, the data bit area is used for storing a user data, and the redundant bit area is used for storing an ECC,
the memory controller is further configured to read a first physical program unit among the physical program units of the first physical erase unit and determine whether an error occurs in the user data in the first physical program unit according to the ECC in the first physical program unit,
wherein if an error occurs in the user data in the first physical program unit, the memory controller is further configured to determine whether an error bit number of the user data exceeds a predetermined value,
if the error bit number exceeds the predetermined value, the memory controller is further configured to determine that the first physical erase unit satisfies the first condition.

10. The memory storage device according to claim 9, wherein the memory controller is further configured to set the predetermined value to an upper limit on a number of error bits correctable to the ECC in the first physical program unit.

11. The memory storage device according to claim 7, wherein the memory controller is further configured to configure a plurality of logical addresses to be mapped to a part of the physical program units, wherein an aggregate of memory spaces corresponding to the logical addresses is an open memory space,
the memory controller is further configured to determine whether an available memory space capacity of the physical erase units is smaller than a capacity of the open memory space after the first physical erase unit is grouped to the second area, wherein the available memory space capacity is a total of capacities of the physical erase units that are available for storing user information,
if the available memory space capacity is smaller than the capacity of the open memory space, the memory controller is further configured to declare that the rewritable non-volatile memory module enters a write protect state.

12. The memory storage device according to claim 7, wherein the memory controller is further configured to establish a mapping table, wherein the mapping table is used for recording the operation mode of each of the physical erase units.

13. A memory controller, adapted to control a rewritable non-volatile memory module, the memory controller comprising:
a host interface, configured to couple to a host system;
a memory interface, configured to couple to the rewritable non-volatile memory module, wherein the rewritable non-volatile memory module comprises a plurality of physical erase units, each of the physical erase units comprises a plurality of physical program unit sets, each of the physical program unit sets comprises a plurality of physical program units, and the physical program units of each of the physical program unit sets comprise a lower physical program unit and an upper physical program unit, wherein a programming speed of the upper physical program units is slower than a programming speed of the lower physical program units; and
a memory management circuit, coupled to the host interface and the memory interface, configured to set an operation mode of each of the physical erase units to comprise a first mode, a second mode, and a third mode, wherein the first mode indicates that the physical program units are programmable, the second mode indicates that the upper physical program units are non-programmable, the third mode indicates that the upper physical program units are non-programmable and the operation mode is unswitchable from the third mode to the first mode or the second mode,
wherein the memory management circuit is configured to group the physical erase units into a first area and a second area, wherein each of the physical erase units in the first area switchably operates in the first mode or the second mode, and the operation mode of each of the physical erase units in the second area is the third mode,
wherein if a first physical erase unit in the first area satisfies a first condition, the memory management circuit is configured to set the operation mode of the first physical erase unit to the third mode and group the first physical erase unit to the second area.

14. The memory controller according to claim 13, wherein the memory management circuit is further configured to determine that the first physical erase unit satisfies the first condition if an erase count of the first physical erase unit is greater than a threshold.

15. The memory controller according to claim 13, wherein each of the physical program units comprises a data bit area and a redundant bit area, the data bit area is used for storing a user data, and the redundant bit area is used for storing an ECC,
the memory management circuit is further configured to read a first physical program unit among the physical program units of the first physical erase unit and determine whether an error occurs in the user data in the first physical program unit according to the ECC in the first physical program unit,
wherein if an error occurs in the user data in the first physical program unit, the memory management circuit is further configured to determine whether an error bit number of the user data exceeds a predetermined value,
if the error bit number exceeds the predetermined value, the memory management circuit is further configured to determine that the first physical erase unit satisfies the first condition.

16. The memory controller according to claim 15, wherein the memory management circuit is further configured to set the predetermined value to an upper limit on a number of error bits correctable to the ECC in the first physical program unit.

17. The memory controller according to claim 13, wherein the memory management circuit is further configured to configure a plurality of logical addresses to be mapped to a part of the physical program units, wherein an aggregate of memory spaces corresponding to the logical addresses is an open memory space,
the memory management circuit is further configured to determine whether an available memory space capacity of the physical erase units is smaller than a capacity of the open memory space after the first physical erase unit is grouped to the second area, wherein the available memory space capacity is a total of capacities of the physical erase units that are available for storing user information,
if the available memory space capacity is smaller than the capacity of the open memory space, the memory management circuit is further configured to declare that the rewritable non-volatile memory module enters a write protect state.

18. The memory controller according to claim 13, wherein the memory management circuit is further configured to establish a mapping table, wherein the mapping table is used for recording the operation mode of each of the physical erase units.
